(19) United States
(12) Patent Application Publication
(10) Pub. No.: US 2009/0293357 A1
(43) Pub. Date: Dec. 3, 2009

(54) AEROPONIC ATOMIZER FOR HORTICULTURE

(76) Inventors: Ross Vickers, Redditch (GB); Brett Charles Bartlett, Redditch (GB)

Correspondence Address: FRASER CLEMENS MARTIN & MILLER LLC, 28366 KENSINGTON LANE, PERRYSBURG, OH, 43551, US

(21) Appl. No.: 12/127,211

(22) Filed: May 27, 2008

(51) Int. Cl. A01G 31/00

(52) U.S. Cl. 47/62 A; 47/62 R

(57) ABSTRACT

Apparatus and method for delivering fine spray of air and nutrient rich liquid to the root area of developing plants with a shaped nozzle end for controlling and varying the dimensions and shape of the delivered fog, and capable of providing a droplet size of between 30 and 80 micron and not below 5 micron. A kit is also provided.

### FIELD OF THE INVENTION

The invention relates to an aeroponics system and method that creates a fine spray of air and nutrient rich liquid that is provided to the root area of developing plants.

### BACKGROUND OF THE INVENTION

Aeroponics is an advanced method of hydroponics where plants are grown without the use of soil or other growing media. The plant root area is suspended inside an enclosed space and supplied with a combination of air and small particles of liquid nutrient solution. The liquid nutrient solution contains the necessary vitamins, minerals and trace elements required for healthy plant growth

An effective aeroponic method is capable of supplying the root area with a simultaneous combination of air and liquid solution enabling a high rate of absorption of both air and liquid nutrient solution at the same time. Traditional methods such as hydroponics and soil growing are less effective at providing a constant and simultaneous supply of air, liquid and nutrients. These traditional methods utilize a specific wet period to supply the water and nutrients plus a dry period to facilitate the absorption of air.

Aeroponics systems suffer from the disadvantage of not being capable of producing the right size of droplets and in the correct air to water ratio that is required to sustain a constant state of effective aeroponic growth while also meeting the liquid requirements for horticulture. Aeroponic systems that produce droplets below 30 microns fail to achieve continuous aeroponic growth due to their need to supply droplets in such a high concentration that liquid saturation occurs whilst meeting the liquid requirement for horticulture. Very small droplet sizes, such as 5-20 microns, need to be supplied in extremely high densities otherwise they cannot provide enough water to actually grow a plant. However, such a high concentration of very small droplets virtually prevents air getting to the roots and thus the roots may die unless the system is turned off periodically in order to allow the roots to dry and gain access to air. Thus, aeroponic systems with droplets below 30 micron tend to be operated with a clear on and off period due to this saturation). Aeroponic systems that produce droplets above 100 microns are also incapable of continuous aeroponic growth due a rapid saturation that is caused by droplets of this size.

There is thus a need for a system that can be run 100% of the time in which the droplets can be absorbed by the roots without saturating them and completely blocking their access to air, which they need to grow.

The majority of aeroponic systems are powered by high pressure water pumps or centrifugal force, and in practice these methods produce liquid droplets of a size and volume that rapidly gather together and saturate the root area causing suffocation. Such types of systems offer very little reward over traditional hydroponics methods due to the fact they need to be operated with a defined wet and dry period.

Ultrasonic aeroponic systems are capable of producing very fine liquid particles of a size below 30 micron but these are also ineffective at continuous aeroponic growth. The ultrasonic components are both expensive and unreliable due to their short life span.

U.S. Pat. No. 4,332,105 discloses an apparatus for aeroponic growth including a perforated support member to directly expose the root portions to the atmosphere, and a spraying apparatus for providing a nutrient mist directly to the exposed root area.

Japanese Patent Application No. 2000188980 discloses a plant culturing apparatus with a compressed air pressurized spray nozzle to provide an air mist of water and nutrition to the covered root part of a plant in which the average particle size of the mist is several microns or less.

Published PCT application WO 85/03195 discloses an aeroponic method and apparatus in which a pressurized hydroatomized mist is dispensed via mist nozzles that are timer and solenoid controlled to regulate the water flow.

U.S. Pat. No. 6,021,602 discloses a modular structure for aeroponic cultivation comprising an electronically controlled feeding, pumping and spraying means.

There is a need for an aeroponics system that provides air and nutrient rich liquid droplets that are fine enough to be supplied to the root area but do not cause the horticulture liquid saturation or suffocation.

The inventor has surprisingly found that droplet micron size for effective aeroponics should be between 30 and 80 micron and not below 5 micron.

### SUMMARY OF THE INVENTION

Accordingly, the present invention provides an apparatus and a kit for liquid atomization of a nutrient rich liquid through air assisted atomizing nozzles providing an atmosphere to horticulture comprising a beneficial concentration in the atmosphere of the atomized nutrient rich liquid having a beneficial liquid droplet size and air to water ratio,

In one aspect, in a first aspect, the invention provides a horticultural apparatus for delivering an atomized liquid mixture of a nutrient rich liquid and air to horticulture comprising growing flowers, plants, vegetables or fruits, the apparatus comprising at least one atomizer, wherein the at least one atomizer is configured to provide an atmosphere to the root area of the horticulture having a concentration of the atomized liquid mixture of up to 0.001% (1×10⁻³%) by volume, and wherein the atomized liquid mixture comprises a liquid droplet size of not less than 30 microns. The concentration may be between about 3×10⁻⁸% and about 9×10⁻⁴% by volume and the liquid droplet size may be between 30 and 80 microns.

In one embodiment, the atomizer comprises a nozzle, the nozzle comprising: first and second mixing chambers, wherein the second mixing chamber is distal to and connected with the first mixing chamber; a liquid orifice configured to connect to a nutrient rich liquid source, wherein the liquid orifice opens into the first mixing chamber; one or more air ports configured to connect to a compressed air supply, wherein the one or more air ports open into the first mixing chamber; and a nozzle outlet at the distal end of the nozzle in connection with and distal to the second mixing chamber. The second mixing chamber may be formed in the shape of a dome. The nozzle outlet may be in the form of a slot having a length of from about 0.9 mm to about 8 mm or having a length of between 50% and 90% of the widest point dome, and having a width of between about 0.3 mm and about 1.4 mm.

In another embodiment, the nozzle further comprises a movable cleaning member configured to be pushed forward into the liquid orifice to clear blockages.

In a further embodiment, the liquid orifice has a diameter of between 0.5 mm and 1.2 mm.

In one embodiment, the liquid orifice has a diameter of 0.9 mm.

In another embodiment, the one or more air ports have a diameter of between 0.6 mm and about 1.2 mm.

In yet another embodiment, the nozzle further comprises an annular air chamber connected in between the one air port with the compressed air supply, wherein the one air port comprises an annular opening of between 0.4 mm and about 1.2 mm.

In a further embodiment, the apparatus comprises a grow container to house the root area of the horticulture within the container, the grow container having one or more apertures in the container wall, wherein the horticulture grows through the one or more apertures and is exposed outside the grow container, and wherein the grow container is configured to be in connection with one or a plurality of the atomizer.

The present invention contemplates that the apparatus may also comprise a nutrient rich liquid source in connection with liquid orifice, and may also comprise a compressed air supply connected with one of: the annular air chamber and the one or the plurality of air ports.

The apparatus may also comprise an air control valve connected between the compressed air supply and the atomizer, and optionally a first timer connected to control the air control valve. The apparatus may also comprise a liquid control valve connected between the nutrient rich liquid source and the atomizer, and optionally a second timer connected to control the liquid control valve.

In a second aspect, the invention provides a method for delivering an atomized liquid mixture of a nutrient rich liquid and air to horticulture, the method comprising: providing a supply of a nutrient rich liquid, a compressed air source and the apparatus of claim 1; supplying compressed air and a nutrient rich liquid to the atomizer, wherein the nutrient rich liquid is atomized to an atomized liquid mixture; and delivering the atomized liquid mixture from the atomizer to the horticulture and providing an atmosphere to the horticulture having a concentration of the atomized liquid mixture of up to 0.001% (1×10⁻³%) by volume, wherein the atomized liquid mixture has a liquid droplet size of not less than 30 micron and not more than 80 micron.

In a third aspect of the invention, an aeroponics liquid atomization kit is provided for delivering to horticulture an atomized liquid mixture of a nutrient rich liquid, the kit comprising the apparatus of claim 1, and optionally one or more of: a supply of compressed air, a supply of nutrient rich liquid; a means for providing air pressure and instructions for use,

Preferred embodiments of the present invention will now be described by way of example only with reference to the accompanying drawings.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 shows one arrangement of a two-nozzle application according to the present invention.

FIG. 2 shows a cross section of one embodiment of an air assisted atomizing nozzle.

FIG. 3 shows a cross-section of one embodiment of a siphon-fed nozzle.

FIG. 4 shows a longitudinal cross-section of one embodiment of the atomizer according to the present invention.

FIG. 5 shows an enlargement of part of the cross section of FIG. 4.

FIG. 6 is a front view of a nozzle member forming part of the atomizer of FIG. 4.

FIG. 7 is a front view of a cover member forming part of the atomizer of FIG. 4.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The apparatus of the invention is used to grow horticulture such as developing flowers, plants, vegetables or fruits. The apparatus delivers nutrient rich liquids via one or more air assisted nozzles to the root area of developing flowers, plants, vegetables or fruits. The apparatus is able to provide a fine atomization of nutrient rich liquid and air having a droplet size of between about 30 and 80 microns which prevents liquid saturation or suffocation.

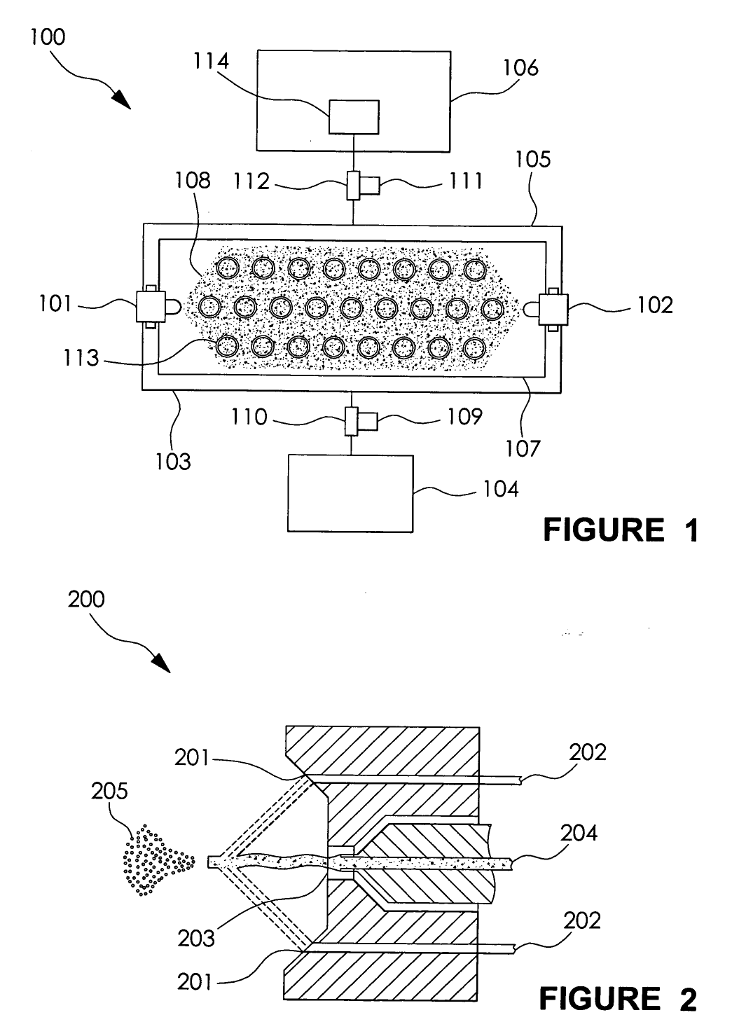

Referring to FIG. 1, in one arrangement (100) of a two nozzle embodiment of the present invention, two air assisted atomizer nozzles (101) and (102) are connected by air line (103) to compressed air supply (104) and also via pipe (105) to a container of nutrient rich liquid (106). The nozzles (101) and (102) are positioned in the external walls of a grow container (107) where they deliver atomized nutrient rich liquid (108) and compressed air to the root area developing in a root volume which is the volume enclosed by the grow container (107). Apertures (113) are provided in the grow container in which plants can be supported with their roots in the root volume. The output of nozzles (101) and (102) is controlled by a timer (109) and a solenoid valve (110) installed between the nozzles and the supply of compressed air (104). A timer (111) and a solenoid valve (112) are installed between the nozzles and the nutrient rich liquid (106).

The atomizer nozzles (101) and (102) deliver a droplet micron size (113) of between 30 and 80 micron and not below 5 micron.

Another optional component is a water pump (114) providing the nutrient rich liquid to the nozzles (101, 102) via the pipe (105).

Referring to FIG. 2, in one embodiment, each air assisted atomizer nozzle (200) comprises an air outlet (201) supplied with compressed air (202) and a nutrient rich liquid orifice (203) supplied by a nutrient rich liquid supply (204). The compressed air supplied at air outlet (201) and the nutrient rich liquid supplied at liquid orifice (203) impact to create a fine atomization (205) of nutrient rich liquid droplets and air. The compressed air supply (202) may be via a conduit, a pipe and such like, or may be in the form of an annular supply configuration leading to the air outlet (201).

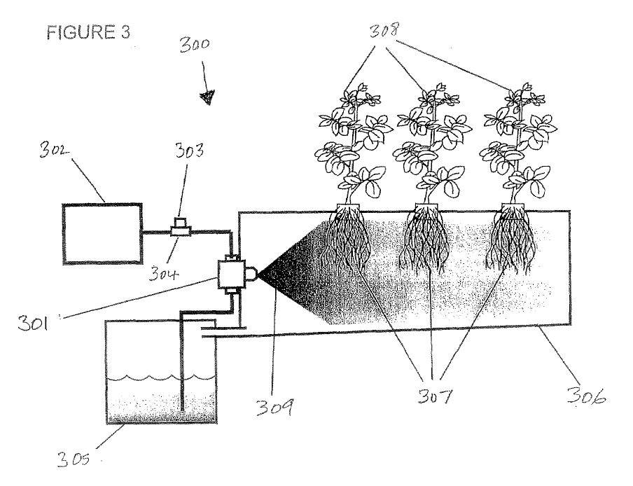

Referring now to FIG. 3, in one embodiment of an aeroponic horticultural apparatus (300) according to the present invention, the air assisted atomizer nozzle (301) is connected to a compressed air supply (302) that is controlled by a timer (303) and a solenoid valve (304). Feeding cycles are controlled by adjusting the timer. The nutrient rich liquid supply (305) is siphon fed to the nozzle (301) where atomization occurs. The nozzle (301) is attached through the external wall of a grow container (306) so as to direct a mist of air and liquid droplets into the root volume within the container, where the root area (307) of the developing flowers, plants, vegetables and the like (308), is exposed and supplied with the atomized nutrient rich liquid (309). FIG. 3 is only one embodiment in which the root areas are growing inside the container and in which the developing horticulture are exposed through apertures in the container wall. The invention also contemplates that the apertures need not necessarily be in the upper part of the container wall but could be on the bottom part or side parts of the container and the horticulture grows accordingly outside the container. Nevertheless, the root area in each case is exposed inside the container.

Unused liquid forms at the base of the grow container (306) and is gravity fed back to the liquid container (305).

In an alternative embodiment of the nozzle arrangement of FIG. 3, the nozzle can also be fed liquid via a water pump or via gravity from a high level container, and not simply as a siphoning nozzle.

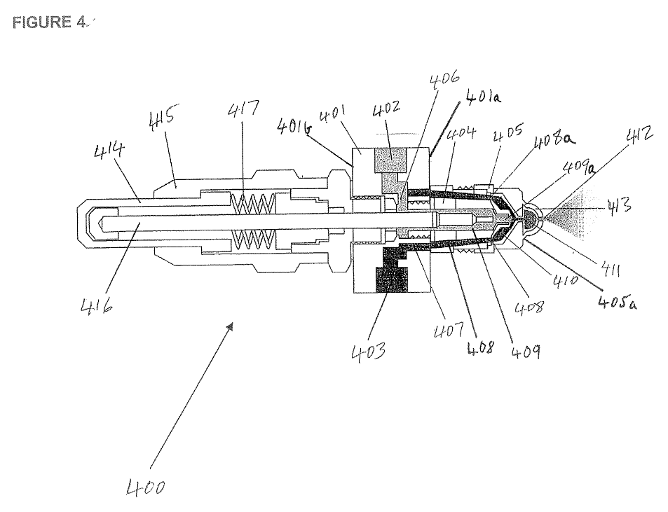

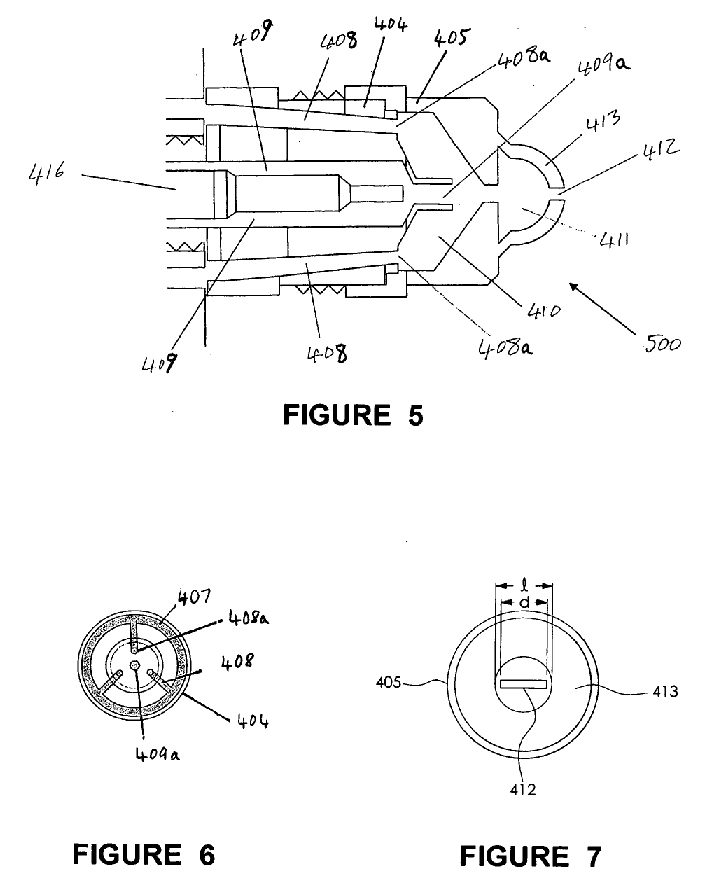

Referring to FIGS. 4 and 5 an atomizing nozzle and plunger arrangement (400) forming part of the apparatus according to one embodiment of the present invention comprises porting block (401), having a liquid inlet port (402), and an air inlet port (403) formed in it. The liquid inlet port is connected to an annular air inlet chamber (407) and the liquid inlet port (403) is connected to a cylindrical liquid inlet chamber (406). The two inlet chambers (406, 407) are concentric and both extend to the front surface (401a) of the porting block, with the air inlet chamber (407) surrounding the liquid inlet chamber (406). A nozzle member (404) is attached to the front face (401a) of the porting block (40). The nozzle member (404) is generally cylindrical with a central bore (409) through it which is aligned with the liquid inlet chamber (406) and ends at a liquid orifice (409a) and a plurality of smaller bores (408) extending through it which are aligned with and connected to the air inlet chamber (407) and end in respective air ports (408a). A cover member (405) is mounted on the front end of the nozzle member (404), and together with the nozzle member 404 defines an, inner mixing chamber (410), into which the liquid orifice (409a) and air ports (408a) open. The cover member (405) has on its front end (405a) a shaped deflector (413) which defines inside it a dome-shaped, substantially hemispherical, outer mixing chamber (411). An atomizer outlet (412) is formed in the front end of the deflector (413), and a connecting passage (413a) is formed in the cover member (405) connecting the inner mixing chamber (410) to the outer mixing chamber (411). A plunger (414) is slidably supported in a plunger housing (415) which is mounted on the rear surface (401b) of the porting block (401). A cleaning needle (416) is connected to the plunger (414) and also extends forwards through the plunger housing (415), the liquid inlet chamber 406 and the bore (409) in the nozzle member (404), stopping just short of the liquid orifice (409a) when in a retracted position as shown in FIG. 4. A return spring (417) acts on the plunger (414) to urge it towards its retracted position. The cleaning needle, from its retracted position, may be pushed forward by means of the sprung plunger 414 to clean any blockage from the liquid orifice (409a).

The liquid inlet chamber (406), supplying the liquid to the liquid orifice (409), and air inlet chamber (407), supplying the compressed air to air port (408), may be designed, in other embodiments, as linear conduits leading directly from the supply sources to the outlets. The invention also contemplates that the compressed air may enter the nozzle via an annular concentric air chamber having an annular air port.

Within the atomizer, compressed air from the air ports (408a) impacts with liquid from the liquid orifice (409a) inside the inner mixing chamber (410) and outer mixing chamber (411). This impact breaks the liquid down into small particles to form a fog of liquid droplets in air. Shaped deflector (413) controls the dimensions and shape of the spray of emitted fog. The atomizer outlet (412), formed in the shaped deflector (413), may be optionally be in the form of an orifice or a rectangular slot arranged horizontally or vertically with respect to the shaped deflector to shape the flow of the mist as it exits the atomizer.

The atomizer outlet (412) may have straight sides (412a) as shown in FIG. 7, or it may be beveled, or otherwise varying in cross section to alter the dimensions or direction of the mist spray emerging from dome-shaped outer mixing chamber (411).

The air ports (408a) have a minimum aperture size of 0.8 mm and the liquid orifice (409a) has a minimum aperture size of 0.8 mm. The outer mixing chamber may be formed in the shape of a dome. The nozzle outlet (412) may be in the shape of a slot extending between the sides of the dome and having a length/(see FIG. 7) measured in the transverse direction perpendicular to the axis of the nozzle, which is between 50% and 90% of the width d of the hemispherical mixing chamber dome at its widest point. Shaped atomizer outlet (412), if round has a diameter of approximately 0.9 mm, or if rectangular has a height in the range from 0.3 to 1.4 mm, in this case of approximately 0.9 mm and a width in the range from 6 to 9 mm, in this case of approximately 7.5 mm. In this embodiment, where the dome is hemispherical, the outlet (412) extends through an angle of between about 60° and 130°

In operation, the output of through one or more nozzles is controlled by solenoid valves connected between the nozzles and the compressed air supply and the container providing the nutrient rich liquid, as determined by the timers. The timers can be programmed to control the feeding cycles by restricting the flow to the nozzles through the solenoid vales, and provide the correct liquid droplet sizes, flow rates and fog distribution required to achieve authentic aeroponic growth. The atomizer is able to operate within a range of air pressures from 8 to 120 psi, and more particularly, 20 to 60 psi.

Droplet micron size for effective aeroponics should be between 30 and 80 micron and not below 5 micron. The present growing method is the first growing method to use this range of microns.

Optimum aeroponic root growth requires a specific concentration of atomized liquid that is suspended inside the grow chamber. If the atmosphere provided by the present apparatus has too high a concentration of the atomized liquid mixture, it may cause saturation of the roots and may restrict the oxygen and carbon dioxide surrounding the root structure, because too much water soaks the roots and blocks their supply of air. In one embodiment of the instant invention, the apparatus provides to the exposed root structure inside the container an atmosphere that has a concentration of the atomized liquid mixture in the atmosphere in a range of between 0.0004% (4×10⁻⁴%) and 0.000000027% (27×10⁻⁹%) by volume of the atmosphere surrounding the horticulture, depending on the plant species. A concentration above 0.0009% (9×10⁻⁴%) by volume of liquid will result in the saturation of the roots and restriction of oxygen and carbon dioxide.

Pressurized air is used to impact with the liquid inside the mixing chambers within the atomizer. This impact breaks the liquid down into small particles. The nozzle tip shape m ay be varied to shape the flow of the mist as it exits the atomizer.

The atomizer optionally further comprises an internal cleaning needle to unblock blockages. Blockages or other problems may be caused by mineral build up due to the evaporation and atomization of plant fertilizers.

In one exemplary mode, the liquid fertilizer is drawn up to the atomizer via the siphoning ability of the atomizer. The liquid fertilizer may also be pumped to the atomizer. Liquid fertilizer may be fed into the atomizer from above via gravity, thus avoiding the need for a liquid pump.

The misting cycles may be controlled by restricting the flow of either liquid or air to the atomizer. The flow of liquid and air may be controlled together or independently. In one embodiment, a repeat cycle timer is used. One or more solenoid valves are used to restrict the flow or air to the atomizer. In a gravity fed system, the flow of liquid and air must be controlled or restricted at the same time. Optionally, a probe or sensor is used to control the level of fog provided to the roots.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An horticultural apparatus comprising at least one atomizer, wherein the atomizer is configured to provide an atomized liquid mixture having a liquid droplet size of not less than 30 microns.

2. The apparatus of claim 1, wherein the liquid droplet size is between 30 and 80 microns.

3. The apparatus of claim 1, wherein the atomizer comprises a nozzle, the nozzle comprising: first and second mixing chambers, wherein the second mixing chamber is connected with the first mixing chamber; a liquid orifice configured to connect to a nutrient rich liquid source, wherein the liquid orifice opens into the first mixing chamber; at least one air port configured to connect to a compressed air supply, wherein the at least one air port opens into the first mixing chamber; and a nozzle outlet in connection with the second mixing chamber.

4. The apparatus of claim 3, wherein the second mixing chamber is formed in the shape of a dome.

5. The apparatus of claim 4, wherein the nozzle outlet is a slot having a length of from about 0.9 mm to about 8 mm or having a length of between about 50% and 90% of the widest point dome, and having a height of between 0.3 and 1.4 mm

6. The apparatus of claim 3, wherein the nozzle further comprises a movable cleaning member configured to be pushed forward into the liquid orifice to clear blockages.

7. The apparatus of claim 3, wherein the liquid orifice has a diameter of between about 0.5 mm and 1.2 mm.

8. The apparatus of claim 3, wherein the one or more air ports has a diameter of between about 0.6 mm and about 1.2 mm.

9. The apparatus of claim 3, wherein the nozzle further comprises an annular air inlet chamber connected between the one air port and the compressed air supply.

10. The apparatus of claim 1, further comprising a grow container to house the root area of the horticulture within the container, the grow container having one or more apertures, whereby the horticulture can grow through the one or more apertures and be exposed outside the grow container, and wherein the atomizer is configured to provide an atmosphere to the horticulture the atmosphere having a concentration of the atomized liquid mixture of up to about 0.001% (1×10⁻³%) by volume.

11. The apparatus of claim 3, further comprising a compressed air supply connected with the at least one air port.

12. The apparatus of claim 3, further comprising a nutrient rich liquid source in connection with liquid orifice.

13. The apparatus of claim 5, further comprising an air control valve connected between the compressed air supply and the atomizer, and optionally a first timer connected to control the air control valve.

14. The apparatus of claim 5, further comprising liquid control valve connected between the nutrient rich liquid source and the atomizer, and optionally a second timer connected to control the liquid control valve.

15. A method for delivering an atomized liquid mixture of a nutrient rich liquid and air to horticulture, the method comprising:
a. providing a supply of a nutrient rich liquid, a compressed air source and the apparatus of claim 1;
b. supplying compressed air and a nutrient rich liquid to the atomizer, wherein the nutrient rich liquid is atomized to an atomized liquid mixture; and
c. delivering the atomized liquid mixture from the atomizer to the horticulture and providing an atmosphere to the horticulture having a concentration of the atomized liquid mixture of up to about 0.001% (1×10⁻³%) by volume, wherein the atomized liquid mixture has a liquid droplet size of between 30 & 80 microns and not less than 5 microns.

16. An aeroponics liquid atomization kit for delivering to horticulture an atomized liquid mixture of a nutrient rich liquid, the kit comprising the apparatus of claim 1, and optionally one or more of: a supply of compressed air, a supply of nutrient rich liquid; a means for providing air pressure and instructions for use.
